(19) United States
(12) Patent Application Publication
(10) Pub. No.: US 2017/0252867 A1
(43) Pub. Date: Sep. 7, 2017

(54) DEVICE AND METHOD FOR PRODUCING A SPRING WIRE, DEVICE AND METHOD FOR MAKING A SPRING WIRE, DEVICE AND METHOD FOR PRODUCING SPRINGS FROM A SPRING WIRE, AND SPRING WIRE

(71) Applicant: Scherdel Innotec Forschungs-und Entwicklungs GmbH, Marktredwitz (DE)

(72) Inventors: Marcus Bach, Marktredwitz (DE); Marco Bauer, Pegnitz (DE)

(21) Appl. No.: 15/510,913

(22) PCT Filed: Sep. 11, 2015
(86) PCT No.: PCT/EP2015/070811

§ 371 Date: Mar. 13, 2017

(30) Foreign Application Priority Data
Sep. 12, 2014 (DE) 10 2014 113 159.2

(51) Int. Cl. B23K 26/362; F16F 1/10; B23K 26/08; B21C 37/04; F16F 1/14

(52) U.S. Cl. CPC B23K 26/362; B21C 37/045; F16F 1/145; B23K 26/0823; F16F 1/10; B21F 35/02

(57) ABSTRACT

A device for producing a spring wire includes a wire production apparatus which is designed such that a spring wire can be produced from a raw material, in particular by drawing; a checking unit which is designed such that the spring wire can be checked for flaws, in particular material flaws and surface flaws; and a laser marking unit which is designed such that defective regions of the spring wire, in particular regions of the spring wire having material and surface flaws, can be marked with a laser marking such that part of the surface of the spring wire can be removed or part of the surface of the spring wire can be tempered in such a manner that the color of the surface of the spring wire is changed in this part. The wire production apparatus is designed such that the spring wire can be guided past the checking unit and past the laser marking unit.

This application is entitled to the benefit of, and incorporates by reference essential subject matter disclosed in PCT Application No. PCT/EP2015/070811 filed on Sep. 11, 2015, which claims priority to German Application No. 10 2014 113 159.2 filed Sep. 12, 2014.

### BACKGROUND OF THE INVENTION

1. Technical Field

The present invention relates to a device and a method for producing a spring wire, a device and a method for marking a spring wire, a device and a method for producing springs from a spring wire, as well as a spring wire.

2. Background Information

Presently spring wires are produced in a continuous process by means of a production device. During this process it may happen that there are defects or flaws occurring in or on the spring wire which often are recognized or identified only insufficiently.

In the further course of processing of such a spring wire so as to form springs, the production process often has to be stopped in case of such wire defects, and the defective region has to be separated therefrom with high expenditure in terms of time and labor.

There is a need, therefore, for more efficient methods and devices that improve spring production capacity and processing, and in particular processing wherein defective spring wire regions can be reliably excluded.

### SUMMARY OF THE INVENTION

The present disclosure is represented by, but not limited to, the subject matter of the independent claims. Advantageous further developments are indicated in the dependent claims.

An inventive device for producing a spring wire comprises the following features: a wire production apparatus which is designed such that a spring wire can be produced from a raw material, in particular by drawing, a checking unit which is designed such that the spring wire can be checked for defects or flaws, in particular material flaws and surface flaws, and a laser marking unit which is designed such that defective regions of the spring wire, in particular regions of the spring wire having material and surface flaws, can be marked with a laser marking such that part of the surface of the spring wire can be removed or part of the surface of the spring wire can be tempered in such a manner that the color of the surface of the spring wire is changed in this part, with the wire production device being designed such that the spring wire can be guided past the checking unit and past the laser marking unit.

An inventive device for marking a spring wire comprises the following features: a supply unit, in particular a supply roller for supplying a spring wire; a checking unit which is designed such that the spring wire can be checked for flaws, in particular for material and surface flaws; and a laser marking unit which is designed such that defective regions of the spring wire, in particular regions of the spring wire having material and surface flaws, can be marked with a laser marking such that a part of the surface of the spring wire can be removed or that a part of the surface of the spring wire can be tempered in such a way that the color of the spring wire is changed in this part; with the supply unit being designed such that the spring wire can be guided past the checking unit and past the laser marking unit.

In accordance with a basic idea of the present invention, an inventive device for producing a spring wire and an inventive method for producing a spring wire are capable of automatically marking defective regions of the spring wire by laser markings, during the ongoing operation of the production process and without interruption of the same.

This kind of spring wire production is efficient and advantageous in terms of costs, as the marking of defective regions does not necessitate an interruption of the production process.

In accordance with a further basic idea of the present invention, an inventive device for marking a spring wire and an inventive method for marking a spring wire are capable of automatically marking defective regions in already produced spring wires in a continuous process by laser markings.

The defective regions can be reliably identified for the subsequent processing steps, without this requiring additional material, which reduces scrap especially as defective regions of the spring wire or springs produced from such defective regions of the spring wire can be simply melted again and processed into new spring wire.

While the spring wire is produced and at the same time defective regions are detected and marked using the inventive device and the inventive method for producing a spring wire, the idea underlying the inventive device and the inventive method for marking a spring wire is that the spring wire has been produced and the defective regions are marked by laser markings in a separate method and on a separate device.

The devices and methods are largely in correspondence with each other and differ from each other mainly in that, in case of the device and the method for producing a spring wire, the spring wire is supplied to the checking unit and the laser marking unit from the wire production apparatus, whereas in case of the inventive device and the inventive method for marking a spring wire, supply of the spring wire is effected by a supply unit, in particular a supply roller.

Unless indicated otherwise, all of the advantages and embodiments explained in the following relate to both aspects of the invention, namely both the inventive device and method for production a spring wire and the inventive device and method for marking a spring wire that has already been produced.

As regards the inventive laser markings for identifying defective regions of the spring wire, there are two variants according to the invention. According to a finding underlying the invention, defective regions of spring wires of conventional spring steel material can be identified both by material removal, i.e. a recess, which constitutes a first variant according to the invention, and can be labeled or marked by tempering, i.e. identified by a surface region that is changed in color, which constitutes a second variant according to the invention.

The laser marking does not necessarily have to be arranged exactly at the location where the defective region is located, but may also be arranged before or after such location. It is merely essential that the spatial relationship between defective region and position of the laser marking is known.

When directing the laser beam onto the surface of the spring wire, material removal is effected in case of the first variant as a result of evaporation of the material. In case of the first variant, the recesses of the laser markings in the surface of the spring wire usually are in a range from 1 μm to 1 mm.

In case of the second variant, the laser marking has a color which is different from the color of the remaining surface of the spring wire so clearly that such a laser marking can be optically recognized in simple manner.

The material of the spring wire is heated locally to a temperature below its melting point. There are created local changes in structure as well as the tempering colors associated therewith. Tempering colors are stable up to temperatures below 200° C., and in case of higher temperatures these changes in structure are reversed, and the labeling disappears.

In case of the second variant, a tempering effect results due to structural changes in the marginal layer. The second variant is an ablation-free process that may deliver very good contrasts between the laser marking and the surrounding area of the spring wire. The material of the spring wire is locally heated only up to a temperature below the melting temperature and below the evaporation temperature. As regards the change in color, the formation of an oxide layer is responsible for this effect.

Immediately after the spring wire production or supply of the spring wire, the spring wire can be passed in-line through a checking unit with subsequent laser marking unit, before the spring wire is wound onto a winding roller. This eliminates the necessity of additional time and an additional transport route for checking and marking the defective regions of the spring wire.

The spring wire can be wound up immediately after marking of its defective regions. A drying phase, which could be necessary e.g. in case of marking using a varnish, is not necessary. The space required for the additionally necessary checking unit and for the additionally necessary laser marking unit is very small

The material-removing marking of a defective region by means of a laser according to the invention makes sure that the thickness of the spring wire does not exceed a corresponding tolerance range. This constitutes a great advantage as compared to a conceivable material-applying marking, especially as wire guide means and wire feed means in the subsequent production steps very often are matched exactly to the geometry of the spring wire.

An inventive device and method for production of a spring wire can also be understood as a further development of the inventive device and method for marking a spring wire, in which the first device feature, supply unit, and the first method feature, supplying, are replaced by the wire production apparatus and the production step of the spring wire, respectively. The right to redraft the first device claim for producing a spring wire and the first method claim for producing a spring wire as respective dependent claims that are dependent on the claims concerning the device and the method for marking a spring wire, is expressly reserved here.

According to a first embodiment that is valid for all versions of the invention, the spring wire according to the invention comprises as material spring steel, in particular SiCr-alloyed spring steel, SiCrV-alloyed spring steel or SiCrNiV-alloyed spring steel.

As alloy constituents for such a spring steel wire, the elements Si, Cr, V and Ni are used. The alloy combinations SiCr, SiCrV, SiCrNiV as well as the differentiation by the qualities FD (static), TD (dynamic) and VD (highly dynamic) are characteristic of alloyed oil tempered and non-tempered spring steel wires (e.g., per DIN 17223, EN 10270-2, and ASTM A229).

The spring wire may be provided as an oil tempered, non-tempered, drawn according to the patent, and stainless spring steel wire.

In accordance with a further embodiment that is valid for all versions of the invention, the spring wire according to the invention has a diameter between 0.5 and 10 mm.

In accordance with a further embodiment, the laser marking unit is designed such that, for removing part of the surface of the spring wire in the defective regions of the spring wire, a laser beam having a temperature above the evaporation temperature of the basic material of the spring wire is directed onto the spring wire.

Common evaporation temperatures of the basic material of the spring wire are in the range of 2000° C. to 4000° C.

For being able to generate a suitable material-removing laser marking on the spring wire, the laser beam needs to impinge on the surface of the spring wire with a corresponding power. The power with which the laser beam is emitted and thus impinges on the surface of the spring wire for creating the desired material removal is dependent on the spot size, the wavelength of the laser, the speed with which the wire is guided past the laser marking unit, and the desired depth of the recess to be produced by material removal. A suitable range for the power of the laser marking unit is from 10 to 100 W. Alternatives are of course possible and comprised as well.

The defective regions of the spring wire are thus reliably marked and can be safely detected in a subsequent processing step.

In accordance with an alternative embodiment, the laser marking unit is designed such that, for tempering part of the surface of the spring wire in the defective regions of the spring wire such that the color of the surface of the spring wire is changed in this part, it directs a laser beam having a temperature of approx. 200° C. to 660° C. onto the spring wire.

For producing laser markings with such a change in color of the surface of the spring wire, the laser beam has to impinge on the surface of the spring wire with corresponding power.

The power with which the laser beam is emitted and thus impinges on the surface of the spring wire for creating the desired change in color is dependent on the spot size, the wavelength of the laser, the speed with which the wire is guided past the laser marking unit, and the desired color of the change in color. A suitable range for the power of the laser marking unit is from 10 to 100 W. Alternatives are of course possible and comprised as well.

Tempering temperatures of approx. 200° C. effect a white-yellow tempering color, of approx. 220° C. a straw-yellow tempering color, of approx. 230° C. a golden yellow tempering color, of approx. 240° C. a yellow-brown tempering color, of approx. 250° C. a brown-red tempering color, of approx. 260° C. a red tempering color, of approx. 270° C. a purple tempering color, of approx. 280° C. a violet tempering color, of approx. 290° C. a dark blue tempering color, of approx. 300° C. a cornflower blue tempering color, of approx. 320 a light blue tempering color, of approx. 340 ° C. a blue-gray tempering color, and of approx. 660° C. a gray tempering color. These temperatures are to be understood with a corresponding tolerance range of plus/minus 5 to 10° C.

Particularly good contrasts and accordingly particularly good optical recognizability of such laser markings are achieved with a straw-yellow, golden yellow, yellow-brown, blue-red, red, purple, violet, dark blue, cornflower blue, and light blue tempering color and with a silver-gray color of the basic material.

In accordance with a further embodiment, the device further comprises a control unit that is connected to the checking unit and the laser marking unit and is designed such that, during operation of the device, it receives signals on defective regions of the spring wire from the checking unit and controls the laser marking unit such that the latter introduces at least one laser marking into these defective regions of the spring wire. Such a control unit permits exact synchronization between the detection of a defective region and the marking of the same, irrespective of the wire feed speed.

In accordance with a further embodiment, the device comprises a laser marking unit, with the laser marking unit having a radiation source and/or a scanner optical system or a projection mask and/or a focusing means which is/are designed such that they are directed towards the moving spring wire.

A laser marking unit comprising a radiation source, a scanner optical system and a focusing means is also referred to as scanner system.

By means of a laser marking unit comprising a radiation source, a projection mask and a focusing means, laser markings can be applied by way of the mask projection method. In said method, the laser beam prior to focusing is sent through the projection mask which defines the shape of the laser marking to be applied and which in particular represents a negative of the laser marking to be applied. The laser marking so to speak is applied in a fast shot. The mask projection method permits more complex structures to be applied at a high processing speed.

Such a laser marking unit is designed such that the laser marking can be introduced along the entire defective region. When a circumferentially broad region and in particular a region of the spring wire extending about the entire circumference of the spring wire is to be marked, it will be necessary to provide one or more laser marking units having a laser beam that can be projected in correspondingly broad manner.

A further embodiment of the invention consists in that the laser marking unit is designed such that the defective regions of the spring wire are marked such that the laser marking forms a machine-readable code, in particular a line code, a barcode or a data matrix code, or a machine-readable text, and/or wherein the laser marking unit is designed such that each defective region is respectively provided with the same laser marking, or that each defective region is respectively provided with an unambiguously distinguishable laser marking, and/or wherein the laser marking contains additional information on the respectively marked defective region.

A machine-readable marking permits reliable mechanical recognition of such defective regions in a subsequent production step, so that the use of checking personnel can be reduced to a minimum as well.

A further embodiment of the invention consists in that the marking unit is arranged or designed such that the laser marking is applied to the defective region or regions of the spring wire such that it extends at least across large part of the circumference of the spring wire, in particular across the entire circumference of the same, or wherein the laser marking is applied to the defective region or regions of the spring wire such that it extends only across a partial region of the circumference of the spring wire.

By way of the variable application of laser markings on a spring wire, it is possible to mark various defects or flaws in different manner. Laser markings extending across a large part of the circumference of the spring wire can be recognized in a subsequent production step in particularly reliable manner

A further embodiment of the invention consists in that the checking unit for checking the spring wire for flaws is designed as optical checking unit, as eddy current checking unit or as flux leakage recognition unit. All three options permit a reliable and non-contacting and thus non-destructive and not material-fatiguing inspection.

A further embodiment of the invention consists in that the checking unit and the laser marking unit are arranged beside each other, wherein in particular the checking unit, as seen in the direction of movement of the spring wire, is arranged in front of or subsequent to the laser marking unit. This design permits reliable checking and marking of the spring wire in the ongoing process, without the production process being slowed down, stopped or reversed. When the checking unit is arranged in front of or upstream of the laser marking unit in the direction of movement of the spring wire, the laser marking can be applied at the location of the spring wire where a defect is detected, or before or subsequent to such location. When the checking unit is arranged subsequent to or downstream of the laser marking unit in the direction of movement of the spring wire, the laser marking is applied downstream of the location where a defect is detected. What is essential is merely that the spatial relationship between defect and laser marking is known to permit the defective regions to be reliably recognized in further processing of the spring wire and to exclude unintentional further processing of the defective regions of the spring wire into springs.

A laser marking applied downstream of the location of the spring wire at which a defect is detected is particularly advantageous when the feeding direction of the spring wire during further processing of the spring wire into springs is the opposite direction, so that the laser marking can be recognized first and the defective location proper follows only thereafter.

A further embodiment of the invention consists in that the device further comprises a winding unit, in particular a roller, onto which the spring wire including the defective region/regions provided with one or more laser markings can be wound.

This ensures that the spring wire produced and marked, respectively, can be wound onto transport rollers which then may be transported to machines for further processing. This constitutes a simple and handy storage and transport possibility for the spring wire.

A further embodiment of the invention consists in that the device comprises at least one wire guide, in particular a first wire guide arranged upstream of the checking unit and the laser marking unit, and a second wire guide arranged downstream of the checking unit and the laser marking unit and upstream of the winding roller.

By way of the first wire guide arranged upstream of the checking unit and the laser marking unit, the spring wire can be guided past the checking unit and the laser marking unit reliably and at all times in the correct position.

By way of the second wire guide arranged downstream of the checking unit and the laser marking unit and upstream of the winding roller, the spring wire having defective regions provided with laser markings can be readily wound onto the winding roller. By moving this wire guide, it is possible to obtain a desired winding pattern.

The invention also relates to a method for producing a spring wire, comprising the following steps: producing, in particular drawing, a spring wire from a raw material; checking the spring wire for defects or flaws, in particular for material and surface flaws; and marking the defective regions of the spring wire by means of a laser marking unit, with the laser marking unit removing part of the surface of the spring wire or with the laser marking unit tempering part of the surface of the spring wire such that the color of said part is changed.

The invention also relates to a method for marking a spring wire, comprising the following steps: supplying a spring wire by means of a supply unit, in particular a supply roller; checking the spring wire for defects or flaws, in particular for material and surface flaws; and marking the defective regions of the spring wire by means of a laser marking unit, with the laser marking unit removing part of the surface of the spring wire or with the laser marking unit tempering part of the surface of the spring wire such that the color of said part is changed.

The advantages and embodiments indicated hereinbefore with respect to the device for producing a spring wire and with respect to the device for marking a spring wire are equally applicable to the inventive method for producing a spring wire and to the inventive method for marking a spring wire, respectively. For avoiding repetitions, these will not be indicated here once more.

In accordance with an embodiment of the method, the laser marking unit directs a laser beam with a temperature above the melting temperature of the basic material of the spring wire onto the spring wire in order to remove part of the surface of the spring wire in the defective regions of the spring wire.

In accordance with an alternative embodiment of the method, the laser marking unit directs a laser beam with a temperature of approx. 200° C. to 660° C. onto the spring wire in order to temper part of the surface of the spring wire in the defective regions of the spring wire such that the color of the surface of the spring wire is changed in this part.

In accordance with an embodiment of the method the defective regions of the spring wire are marked by means of a laser marking unit such that the laser marking forms a machine-readable code, in particular a line code, a barcode or a data matrix code, or a machine-readable text.

By means of a machine-readable marking, reliable mechanical recognition of such defective regions is rendered possible in a subsequent production step, so that the use of inspection personnel can be reduced to a minimum as well.

In accordance with an embodiment of the method the defective regions of the spring wire are marked by means of a laser marking unit such that each defective region is respectively provided with the same laser marking. This constitutes the simplest marking variant in accordance with the invention. The laser marking reliably identifies any defective region.

In accordance with an embodiment of the method, the defective regions of the spring wire are marked by means of a laser marking unit such that each defective region is respectively provided with an unambiguously distinguishable laser marking. Each laser marking thus is unambiguously associated with a defective region.

In accordance with an embodiment of the method, the laser marking contains additional information on the respectively marked defective region. By way of such additional information it is possible to introduce into the spring wire, beyond the information that the respective region of the spring wire is defective, many other items of information on the type of the flaw and to make the same available for a subsequent spring production machine, such as e.g. the information on the number of the current flaw on the spring wire, the information on the kind of the flaw, e.g. material or surface flaw, additional information on the kind of the material or surface flaw or spring wire dimensions in the defective region.

In a further embodiment of the invention the laser marking is applied to the defective region or regions of the spring wire such that it extends at least across large part of the circumference of the spring wire, in particular across the entire circumference of the same. Such a laser marking can be detected in particularly reliable manner in a subsequent method step. For introducing such a laser marking, there have to be provided one or more laser marking units having a laser beam that can be projected in correspondingly broad manner

In a further embodiment of the invention, the laser marking is applied to the defective region or regions of the spring wire such that it extends only across a partial region of the circumference of the spring wire. Such a laser marking can be produced in particularly simple and inexpensive manner, as it is possible to provide only one laser marking unit having a laser beam that can be projected in correspondingly broad manner

In accordance with a further embodiment of the method, the method steps of checking the spring wire for flaws or defects and of marking the defective regions of the spring wire are carried out during continuous movement of the drawn wire.

This embodiment permits an increase in productivity of the spring wire production and spring wire marking, respectively. Downtimes are reduced or avoided completely.

In accordance with a further embodiment of the method it is possible, when the laser marking is introduced into the spring wire as a recess, to adjust the depth of removal of the laser marking(s) by changing the power of the laser source.

In accordance with a further embodiment of the method it is possible, when the laser marking is introduced into the spring wire as a change in color, to adjust the tempering color of the laser marking(s) by changing the power of the laser source.

This ensures that the method can also be employed with very thin spring wires.

In a further embodiment of the invention the laser marking unit comprises a radiation source and/or a scanner optical system or a projection mask and/or a focusing means, which is/are designed such that they are directed towards the moving spring wire.

Such a laser marking unit is designed for introducing the laser marking along the entire defective region. When a circumferentially broad region and in particular a region of the spring wire extending about the entire circumference of the spring wire is to be marked, there need to be provided one or more laser marking units having a laser beam that can be projected in correspondingly broad manner

A further embodiment of the method consists in that the checking of the spring wire for flaws is effected by means of an optical checking method, by means of an eddy current checking method or by means of flux leakage checking method. All three options permit a reliable and non-contacting and thus non-destructive and not material-fatiguing inspection.

The invention also relates to a device for producing springs from a spring wire, comprising: a spring wire supply unit, in particular a supply roller, for supplying spring wire in which defective regions, in particular regions having material and surface flaws, are marked with a laser marking; a recognition unit which is designed such that it recognizes laser markings on the spring wire; a spring production unit, in particular a coiling machine, which is designed such that springs can be produced from the spring wire continuously and without interruption, and in particular can be coiled and cut to length; and a discharge unit, in particular a discharge duct having a switch, which is designed such that springs produced from spring wire without laser marking are discharged into a first area; in particular a container with non-defective springs, and springs produced from spring wire with laser marking are discharged into a second area, in particular a container with defective springs.

In accordance with a basic idea of the present invention the inventive device for producing springs from a spring wire and the inventive method for producing springs from a spring wire are capable of producing springs from a spring wire in continuous and uninterrupted manner, thus providing for low machine downtimes, high efficiency and low production costs. Interruption of the spring production process can be avoided in that defective spring wire regions are equally processed to form springs which, however, are automatically sent to a different discharge container and thus are sorted out and made available for reuse.

Defective regions of the spring wire are recognized automatically so that quality problems due to non-recognized defective springs are avoided.

By means of the spring wire supply unit, a spring wire roller, in which defective regions are marked with laser markings, can be employed and deliver the spring wire necessary for production.

The recognition unit renders possible that the laser marking can be read mechanically. Defective regions can be recognized in faster and safer manner by such a recognition unit than is possible for a skilled worker.

By means of the spring production unit, the device is capable of automatically processing the spring wire into springs. Such a spring production unit is also referred to as spring coiling machine and need not be explained here in more detail, as it is known to the skilled person.

By means of the discharge unit, the springs produced are sorted automatically into springs of non-defective spring wire and springs of defective spring wire. This classification takes place in the production process in-line subsequent to the spring production unit, so that the production need not be stopped at any time. This leads to increased productivity and cost savings.

The containers below the discharge unit may be replaced within very short periods of time once they are filled. Replacement of the same can be effected in the ongoing process when the empty container pushes the full container out of the device. This ensures a production process that is more effective in terms of time.

A further embodiment of the device consists in that the containers are equipped with a sensor which is designed to detect the number of the springs located in the container.

In a further embodiment of the device the position of the switch is variable between two positions, namely a first position in which springs produced from spring wire without laser marking are fed into a container with non-defective springs, and a second position in which springs produced from spring wire with laser marking are fed into a container with defective springs.

The inventive device and method for producing springs from a spring wire are suitable for producing a multiplicity of springs of various spring types, in particular compression springs, tension springs, torsion bar springs, torsion springs or spiral springs.

In accordance with a further embodiment of the device, the latter further comprises a control unit connected to the recognition unit and the discharge unit and designed such that, during operation of the device, it receives signals on defective regions of the spring wire from the recognition unit and controls the discharge unit such that springs produced from the defective region of the spring wire are fed to the second area, in particular the container with defective springs.

The control unit makes sure that the defective springs are fed automatically into the container with defective springs.

In a further embodiment of the device, the recognition unit is designed as optical recognition unit, as eddy current recognition unit or as a flux leakage recognition unit. When the laser markings are formed as recesses in the surface of the spring wire, all three options permit a reliable and non-contacting recognition of defective spring wire regions provided with laser markings. When the laser markings are present in the form of regions of the surface of the spring wire that are changed in color, only a recognition unit designed as optical recognition unit is capable of reliably detecting the defective spring wire regions provided with laser markings.

In accordance with a further embodiment of the device, the spring production unit comprises a feeder unit arranged downstream of the recognition unit.

The invention also relates to a method for producing springs from a spring wire, comprising the following steps: supplying spring wire, in which defective regions, in particular regions having material and surface flaws, are marked with a laser marking, by means of a spring wire supply unit; recognizing laser markings on the spring wire by means of a recognition unit; continuous and uninterrupted production, in particular coiling and cutting to length of springs from the spring wire by means of a spring production unit; discharging those springs that were produced from spring wire without laser marking into a first area, in particular a container with non-defective springs, and discharging those springs that were produced from spring wire with laser marking into a second area, in particular a container with defective springs, by means of a discharge unit, in particular a discharge duct having a switch.

The advantages and embodiments indicated hereinbefore with respect to the device for producing springs from a spring wire are equally applicable to the inventive method for producing springs from a spring wire. For avoiding repetitions, these will not be indicated once more.

The invention also relates to a spring wire comprising the following features: a raw material, in particular of spring steel, having a substantially constant elongated outline, wherein defective regions of the spring wire, in particular regions of the spring wire having material and surface flaws, are marked with a laser marking in which the surface of the spring wire is recessed in relation to the surface of adjacent regions and with respect to the longitudinal central axis, or in which the surface of the spring wire is changed in color with respect to the surface of adjacent regions.

With such a spring wire, the defective regions can be recognized automatically and reliably, directly during the production of springs from such wire. With a corresponding setup of the device for producing springs from a spring wire, defective spring wire regions may be equally processed into springs which, however, are automatically passed to a different discharge container and thus are sorted out and made available for reuse. Such a spring wire according to the invention therefore can be processed into springs in particularly efficient and inexpensive manner.

In a first embodiment of the spring wire and in case the laser markings are provided in the farm of recessed surface regions of the spring wire, the recess has a depth from 10 μm to 1 mm as measured from the non-recessed surface to the longitudinal central axis.

In an alternative embodiment of the spring wire and in case the laser markings are provided in the form of surface regions of the spring wire that are changed in color, the color of the surface regions of the spring wire that are changed in color comprises white-yellow, straw-yellow, golden yellow, yellow-brown, brown-red, red, purple, violet, dark blue, cornflower blue, light blue, blue-gray or gray, with the color of the remaining surface regions of the spring wire that are not changed in color being silvery-gray.

In a further embodiment of the spring wire the laser marking forms a machine-readable code, in particular a line code, a barcode or a data matrix code, or a machine-readable text, and/or wherein each defective region is respectively provided with the same laser marking, or wherein each defective region is respectively provided with an unambiguously distinguishable laser marking and/or wherein the laser marking contains additional information on the respectively marked defective region.

In a further embodiment of the spring wire the laser marking extends at least across large part of the circumference of the spring wire, in particular across the entire circumference of the same, or wherein the laser marking extends only across a partial region of the circumference of the spring wire.

As regards the advantages of these embodiments, reference is made to the advantages indicated hereinbefore with respect to the device and method for producing a spring wire for avoiding repetitions.

### BRIEF DESCRIPTION OF THE DRAWINGS

The invention will be explained in more detail in the following on the basis of embodiments with reference to the accompanying drawings in which:

FIG. 1 shows a schematic view of a spring wire production device according to a first embodiment of the present invention;

FIG. 2 shows a schematic view of a spring wire marking device according to a second embodiment of the present invention;

FIG. 3 shows a schematic view of the laser marking unit of the spring wire production device of FIG. 1 or the spring wire marking device of FIG. 2 and the spring wire guided past the same, with the defective regions thereof being marked by the laser marking unit;

FIGS. 4A-4D show longitudinal and transverse cross-sectional views of exemplary regions of a spring wire;

FIGS. 5A and 5B show respective schematic views of a spring wire in which four defective regions along the longitudinal extension of the spring wire have been provided with laser markings;

FIGS. 6A-6C show exemplary illustrations of defective spring wire regions with different laser markings; and

FIG. 7 shows a schematic illustration of a device for producing springs from a spring wire according to a further embodiment of the invention.

### DETAILED DESCRIPTION OF THE INVENTION

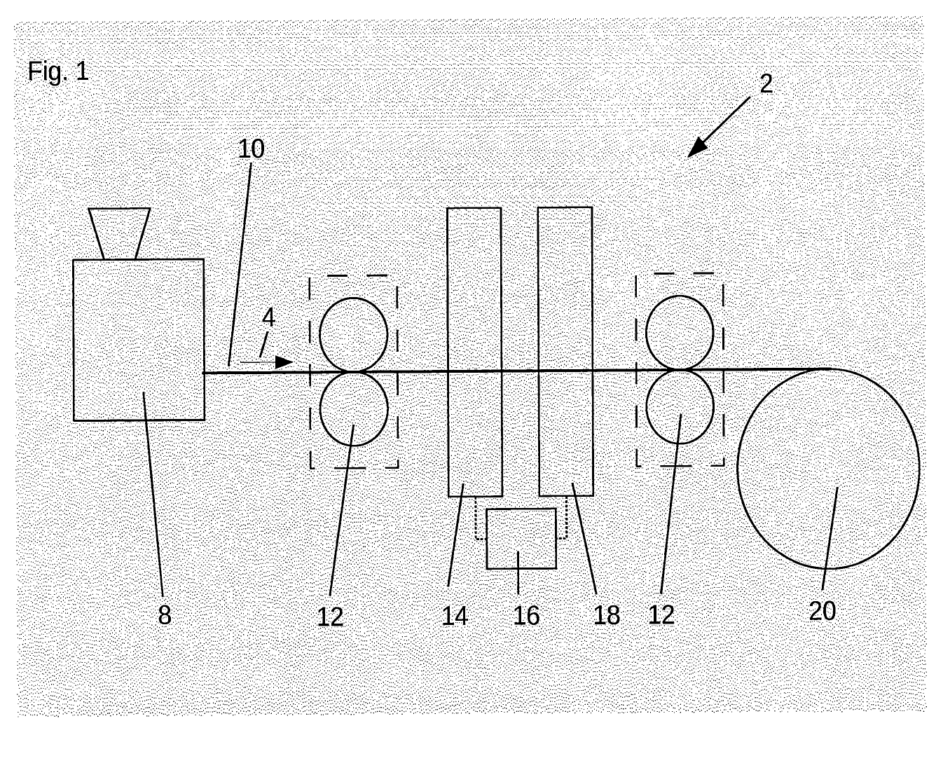

FIG. 1 shows a schematic illustration of a spring wire production device 2.

The spring wire production device 2 comprises a wire production apparatus 8, a first wire guide 12, a checking unit 14, a laser marking unit 18, a control unit 16, an additional wire guide 12 and a winding roller 20.

The wire production apparatus 8 is designed such that a spring wire 10 can be produced from a raw material, in particular by drawing. This is known to the skilled person and need not be explained in more detail here.

The spring wire 10 is produced continuously by the wire production apparatus 8 and leaves the same towards the right in FIG. 1 and successively passes the first wire guide 12, the checking unit 14, the laser marking unit 18 and the additional wire guide 12, and is finally wound onto winding roller 20. The movement direction of the spring wire 10, which is from left to right in FIG. 1, is indicated by an arrow bearing reference numeral 4.

By means of the wire guide 12 arranged upstream of the checking unit 14 as well as the wire guide 12 arranged downstream of the laser marking unit 18, the spring wire 10 is guided so exactly that the checking unit 14, which in particular is arranged in stationary manner, is capable of accurately checking the spring wire 10, and the laser marking unit 18, which in particular is arranged in stationary manner, is capable of accurately marking defective regions of the spring wire 10.

The wire guides 12 thus can be formed in particular as a pair of guide rollers rotating in opposite directions and having the spring wire 10 extending between the same.

The checking unit 14 is designed such that it checks the spring wire 10 for flaws, in particular for material and surface flaws. The checking unit 14 may be in the form of an optical checking unit or an eddy current checking unit.

During operation of the spring wire production device 2, the spring wire 10 is continuously moved past the checking unit 14 and the laser marking unit 18, which check the spring wire during movement of the same for material and surface flaws and, in case such flaws are detected, provide the corresponding regions of the spring wire 10 with a laser marking 18.

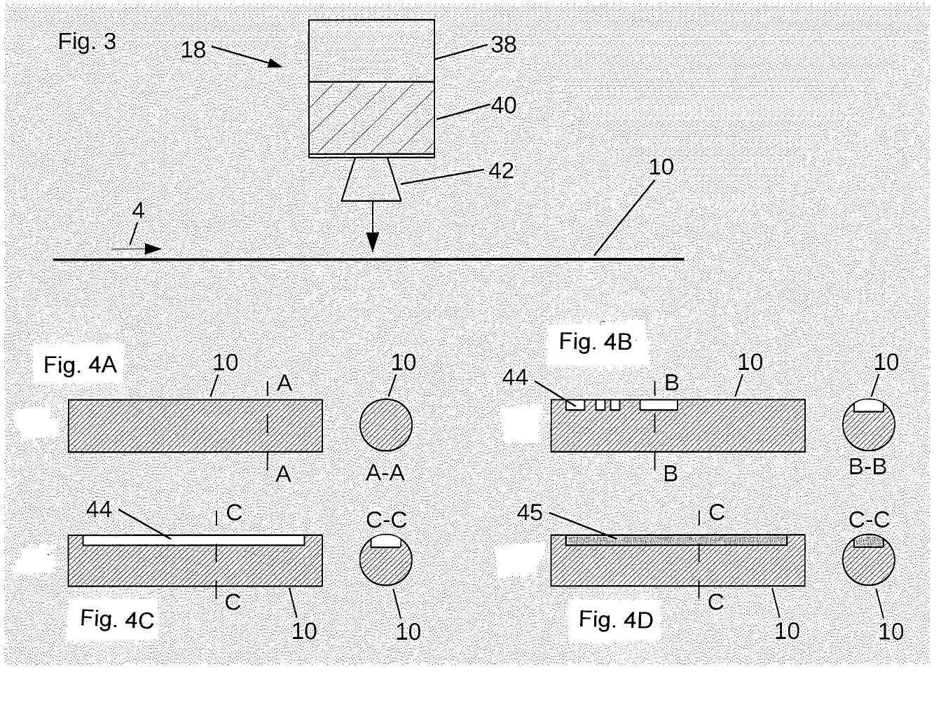

When the checking unit 14 recognizes material or surface flaws of the spring wire 10, it issues a corresponding signal to the control unit 16 which then controls the laser marking unit 18, which is arranged subsequent to the checking unit 14 in the direction of movement of the spring wire 10, so as to apply a suitable laser marking to these defective regions of the spring wire 10. Exemplary laser markings are illustrated and described in FIGS. 4 to 6 below.

The laser marking unit 18 is designed such that the defective regions of the spring wire 10 are identified by a laser marking such that part of the surface of the spring wire 10 is removed, so that the spring wire 10, in the defective regions determined, has one or more recesses in its surface.

To this end the laser marking unit 18 directs a laser beam, having a temperature above the evaporation temperature of the basic material of the spring wire 10, to the regions of the surface of the spring wire 10 to be marked, so that part of the material of the spring wire evaporates and a corresponding, defined recess is created in the spring wire 10.

As an alternative, the laser marking unit 18 is designed such that the defective regions of the spring wire 10 are marked with a laser marking such that part of the surface of the spring wire 10 is changed in color as compared to the adjacent regions of the surface of the spring wire 10. To this end, the laser marking unit 18 directs a laser beam onto the corresponding regions of the surface of the spring wire 10, effecting a tempering temperature between 200 and 660° C. in the surface of the spring wire 10, so that an oxide layer is created the color of which is dependent on the respective tempering temperature, as will be described in a different location of this patent application.

The laser marking unit 18 to this end is directed onto the moving spring wire 10 and, when correspondingly driven by the control unit 16 removes part of the surface of the spring wire 10 or, respectively, changes the color in'said part of the surface of the spring wire 10 by means of a laser beam directed to the spring wire 10.

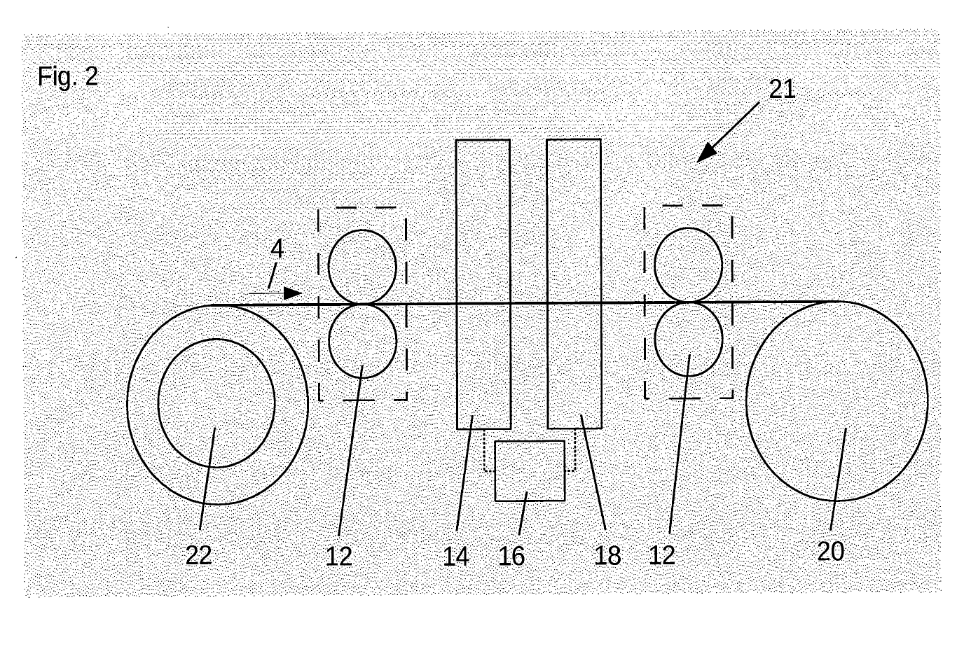

The laser marking unit 18 to this end comprises a radiation source and in addition may also comprise a scanner optical system or a projection mask and a focusing means which in the following are illustrated in exemplary manner with reference to FIG. 3.

When the checking unit 14 detects no material or surface flaws of the spring wire 10, the laser marking unit 18 is controlled by the control unit 16 so as to apply no laser markings to the spring wire 10.

Finally, the finished spring wire 10, the defective regions of which have been provided with laser markings, is wound onto the winding roller 20.

At the end of the production process, there is either no further raw material replenished in the wire production apparatus 8, so that the production process ends by itself As an alternative, the spring wire 10, possibly after stopping of the production process, may also be cut off or cut to length. The winding roller 20 having the spring wire 10 wound onto the same then may be removed completely and transported to a spring production device. Thereafter, a new empty winding roller instead of the removed winding roller can be provided for the next production process.

It is emphasized once more at this location that the checking of the spring wire 10 and the marking of defective regions of the spring wire 10 by the checking unit 14 and the laser marking unit 18 takes place in-line, i.e. during the production process, without the same having to be slowed down or even stopped. This constitutes a particularly efficient, rapid and inexpensive manner of producing spring wire 10, in which at the same time the defective regions can be recognized easily and directly for the subsequent spring production process.

It is to be understood that the control unit 16 can be connected in addition to the wire production apparatus 8 or the supply roller 22 as well as to the winding roller 20 or can be connected to a control unit of the wire production apparatus 8, the supply roller 22 and the winding roller 20 or can be formed in integrated manner with the same, so that the wire production proper, the feeding speed of the spring wire 10 and winding of the spring wire 10 onto the winding roller 20 can be controlled.

FIG. 2 shows a schematic illustration of a spring wire marking device 21.

This spring wire marking device 21 in essence corresponds to the spring wire production device 2, with a supply roller 22 being provided instead of the wire production apparatus 8.

Like elements are provided with the same reference numerals. For avoiding repetitions, these elements as well as the manner of operation of the same will not be explained again.

The supply roller 22 supplies the spring wire produced in a previous production step and, in particular, drawn from a raw material, via the wire guide 12 to the checking unit 14 and the laser marking unit 18, where the spring wire 10 is checked and defective regions of the same are marked, before the spring wire 10 is passed through the second wire guide 12 to the winding roller 20 and is wound onto the same.

The main difference between the spring wire production device 2 of FIG. 1 and the spring wire marking device 21 of FIG. 2 consists in that in the spring wire production device 2 the wire production apparatus 8 constitutes the first part, so that the spring wire 10 is produced and defective regions of the same are detected and marked in one and the same device. In contrast thereto, in case of the spring wire marking device 21, an already produced spring wire 10 is provided which usually is wound onto a roller 22, and this spring wire 10 is supplied via the wire guide 12 to the checking unit 14 and the laser marking unit 18. The production of the spring wire as well as the detection of the defective regions thus is effected at two different locations in case of the spring wire marking device 21.

FIG. 3 shows a schematic illustration of the laser marking unit 18 and the spring wire 10 guided past the same, with the defective regions of the spring wire 10 being marked by means of the laser marking unit 18.

The laser marking unit 18 comprises a radiation source 38 for generating a laser beam, a scanner optical system 40 or a projection mask, as well as a focusing means 42. The laser marking unit 18 is arranged such that it is directed onto the moving spring wire 10 and is designed such that the laser beam, when directed onto the moving spring wire 10, is capable of removing regions of the surface of the same in order to apply a laser marking forming a recess in the surface of the spring wire 10, or is designed such that the laser beam, when directed onto the moving spring wire 10, can change the color of this surface region by way of the tempering effect caused by a structural changes in the marginal layer, in order to apply a laser marking to the spring wire 10. The manner in which the radiation source 38, the scanner optical system 40 or the projection mask and the focusing means 42 need to be designed in detail for causing this effect, is known to the skilled person and need not be elucidated in more detail here.

FIG. 4, by way of its four partial FIGS. 4A, 4B, 4C and 4D, illustrates respective longitudinal and transverse sectional views of exemplary portions of a spring wire 10.

In the partial FIGS. 4A, 4B, 4C and 4D, a respective longitudinal sectional view illustrates a sectional line A-A, and the transverse sectional view is cut along this sectional line A-A.

In accordance with partial FIG. 4A, the illustrated portion of the spring wire 10 has a constant elongated outline and has no material or surface flaws, so that this portion of the spring wire 10 has no laser marking.

In accordance with partial FIGS. 4B, 4C and 4D, the portions illustrated of the spring wire 10 have material or surface flaws not shown here and therefore have each been provided with a laser marking 44 by the laser marking unit 18.

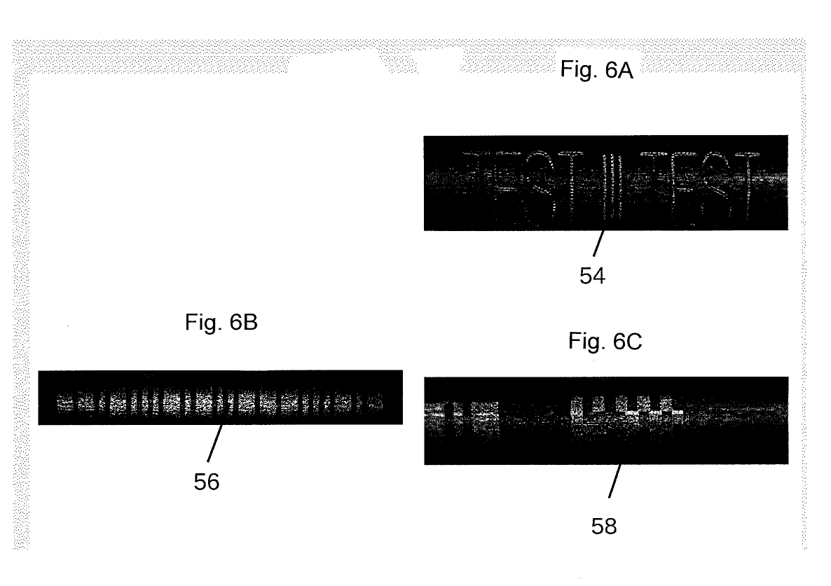

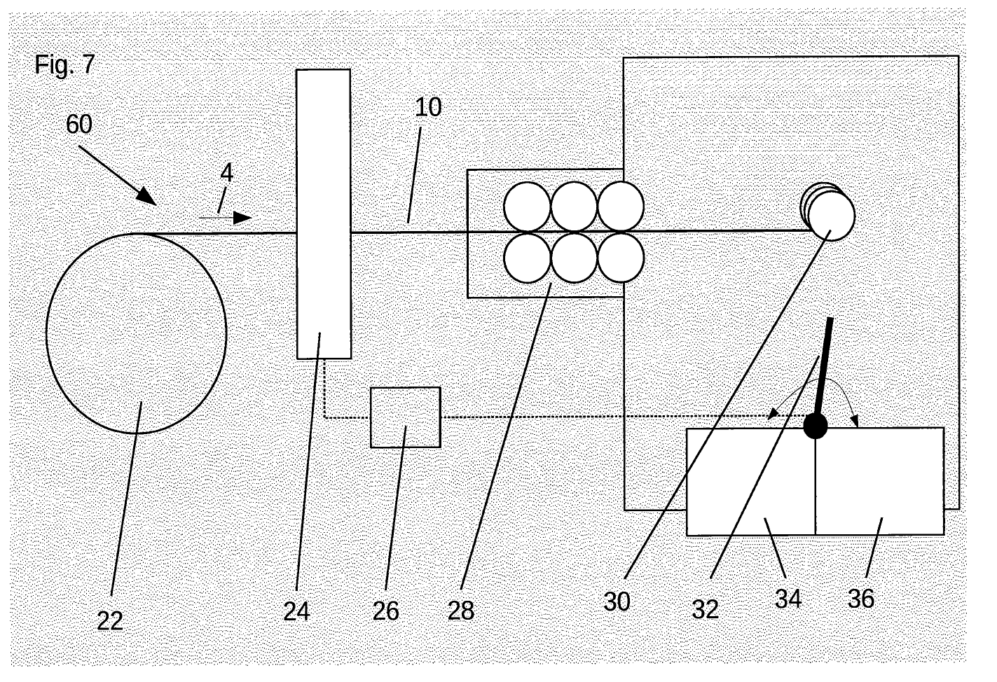

It can be seen in the longitudinal sectional view of partial FIG. 4B that the laser marking 4 has mutually spaced apart recesses which each have been introduced into an upper region of the spring wire 10 only. Such a laser marking with several recesses introduced may be an introduced machine-readable code as will be explained in more detail in the following with reference to FIG. 6.

In accordance with partial FIG. 4C, the laser marking 44 applied is a continuous elongated recess introduced on the top side of the upper region of the spring wire 10. This is an elongated marking on the top side of the spring wire 10 that is recognized by an optical recognition unit or a viewer as an elongated line or an elongated bar.

In accordance with partial FIG. 4D, the laser marking 45 applied is a surface region that has been changed in color by tempering by means of a laser beam and has been introduced on the top side of the upper region of the spring wire 10.

This is an elongated marking at the top side of the spring wire 10 which, as in case of partial FIG. 4C, is perceived by an optical recognition unit or by a viewer as an elongated line or an elongated bar.

For example, the surface of the spring wire 10 may be bare and may have a silver-gray color, whereas the laser marking 45 has a brown-red color that has been introduced into the surface of the spring wire 10 by means of a laser beam having a tempering temperature of approx. 250° C. This yields an optically very well perceivable/detectable contrast. It is of course also possible that the basic color of the surface of the spring wire 10 has a color different from silver-gray, and of course, the color of the laser marking 45 may be different as well, for example white-yellow, straw-yellow, golden yellow, yellow-brown, red, purple, violet, dark blue, cornflower blue, light blue or blue-gray. The tempering temperatures necessary therefor are indicated at another location of this patent application.

It is emphasized here once more that the laser markings introduced do not have the purpose of identifying the spring wire 10 as such, but rather are intended to mark merely the defective regions which are to be recognized automatically in a subsequent spring production process, so that the springs produced from such regions can be automatically singled out.

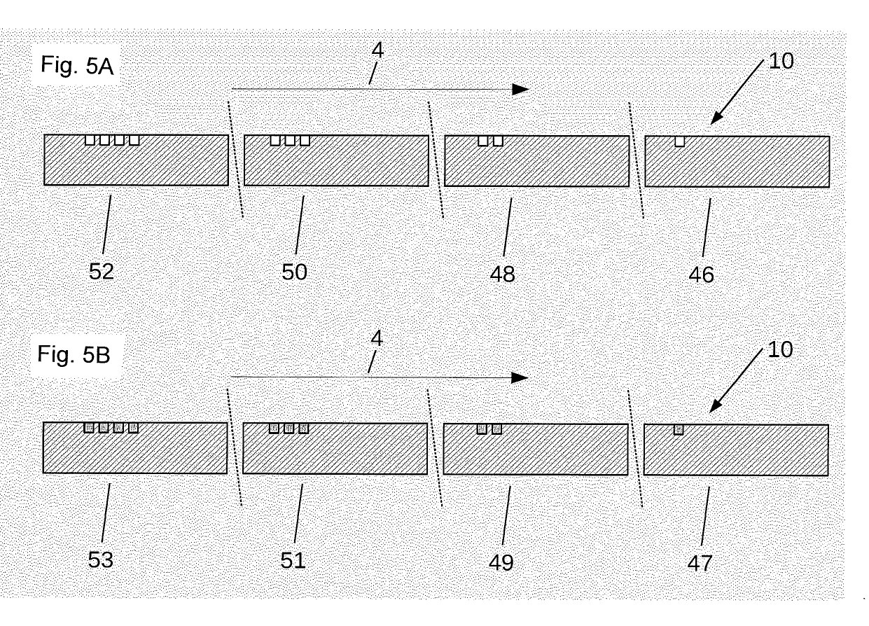

FIG. 5 by way of its two partial FIGS. 5A and 5B illustrates schematic views of a spring wire 10 in which four defective regions have been provided with laser markings 46, 48, 50 and 52 as well as 47, 49, 51 and 53, respectively, along the longitudinal extension of the spring wire 10.

In partial FIG. 5A the laser markings 46, 48, 50 and 52 are provided in the form of recesses in the surface of the spring wire 10, which have been created e.g. by means of a laser beam having a temperature above the evaporation temperature of the basic material of the spring wire 10.

In partial FIG. 5B the laser markings 47, 49, 51 and 53 are provided in the form of ablation-free surface regions of changed color which for example have been introduced in the surface of the spring wire 10 by means of a laser beam having a defined temperature. The colors of the surface regions brought about by various tempering temperatures are explained elsewhere in this patent application. In practical application it is important that an optically well perceivable/detectable contrast between the color of the surface of the spring wire 10 in the laser markings 47, 49, 51 and 53 and the adjacent regions of the surface of the spring wire 10 results.

The laser markings 46 and 47, respectively, shown in the frontmost position, i.e. to the very right in FIG. 5A and FIG. 5B, each comprise a transversely extending laser marking on the top side of the spring wire 10 which is perceived by a recognition means or a viewer as a transverse line.

The second laser markings 48 and 49, respectively, from the front each comprise two spaced apart transversely extending laser markings on the top side of the spring wire 10, which are perceived by a recognition means or a viewer as two parallel transverse lines.

The third laser markings 50 and 51, respectively, from the front each comprise three spaced apart transversely extending laser markings on the top side of the spring wire 10, which are perceived by a recognition means or a viewer as three transverse lines.

The rearmost laser markings 52 and 53, respectively, each comprise four spaced apart transversely extending laser markings on the top side of the spring wire, which are perceived by a recognition means or a viewer as four transverse lines.

Accordingly, each defective region of the spring wire 10 is provided with an unambiguously distinguishable laser marking 46-52, which in the present embodiment are of exemplary nature only. For example, it is possible to associate with the first marking 46 and 47, respectively, the meaning “first defective region in the entire spring wire”, with the second laser marking 48 and 49, respectively, the meaning “second defective region in the entire spring wire”, and so on.

FIG. 6 by way of its partial FIGS. 6A, 6B and 6C shows exemplary illustrations of defective spring wire regions with different laser markings.

All of these laser markings have in common that the markings introduced constitute recesses in the surface of the spring wire 10 or regions of the surface of the spring wire 10 with changed color.

The laser marking 54 constitutes a pattern introduced into the surface of the spring wire 10, which is perceived by a recognition means or a viewer as “TEST, three transverse lines, TEST”, and thus as a third test laser marking applied identifying a defective region of the spring wire 10.

The laser marking 56 constitutes a barcode which, in contrast to the laser markings described hereinbefore, does not only extend over the top side of the spring wire 10, but around the entire circumference of the spring wire 10. Laser marking 56 constitutes a pattern of circumferential recesses or regions with changed color of different width, with respective spring wire regions located therebetween having the original, non-recessed circumference or the non-recessed height, or having the respective spring wire regions of unchanged color located therebetween, respectively.

The laser marking 56 formed as such a barcode can be recognized in particular by a recognition means. In addition to the information, that the respective region of the spring wire 10 is defective, such a barcode laser marking 56 is capable of introducing into the spring wire 10 numerous other items of additional information on the kind of the flaw and make the same available for a subsequent spring production machine, e.g. the information on the number of the current flaw on the spring wire 10, the information on the kind of the flaw, e.g. material or surface flaw, additional information on the kind of the material or surface flaw or spring wire dimensions in the defective region.

The laser marking 58 constitutes a so-called data matrix code which extends only across part of the circumference of the spring wire 10 and forms a pattern of recesses or regions of changed color, which have been introduced into the surface of the spring wire 10.

Such a laser marking in the form of a data matrix code can be recognized in particular by a recognition unit. Similar to the laser marking 56 provided in the form of a barcode, such a laser marking 58 is capable of introducing into the spring wire 10 a multiplicity of items of information on the defective region and making the same available for a subsequent spring production machine.

It is to be understood that the laser marking unit 18 has to be designed such that it is capable of introducing laser markings into the circumferential region of the spring wire 10 in which the laser marking is to be produced.

When a circumferentially broad region and in particular a region of the spring wire extending about the entire circumference of the spring wire 10 is to be marked, it is necessary to provide one or more laser marking units 18 having a laser beam that can be projected in correspondingly broad manner.

In case of a very simple embodiment that is not illustrated here in a separate figure, the laser marking unit 18 is designed such that it provides any defective region with a simple, identical laser marking.

FIG. 7 shows a schematic illustration of a device 60 for producing springs from a spring wire, according to a further embodiment of the invention.

This spring production device 60 comprises a supply roller 22, a recognition unit 24, a spring wire supply unit 28, a spring production unit 30, a discharge unit comprising a container for defective springs 42 and a container for intact or non-defective springs 36, as well as a control unit 26.

The supply roller 22 may be the winding roller 20 onto which the spring wire 10 produced has been wound and the defective regions of which have been provided with corresponding laser markings.

This spring wire 10 is passed through a recognition unit 24 and via the spring wire supply unit 28 to the spring production unit 30 proper, where the spring wire is reshaped, in particular coiled and cut to length into separate springs which then are passed to the discharge unit 32 via a discharge duct not shown here.

The recognition unit 24 is designed such that it recognizes laser markings on the spring wire 10 while the latter is continuously guided through the same. The recognition unit may be in the form of an optical recognition unit, an eddy current recognition unit or a flux leakage recognition unit. In the event that the laser markings are formed as recesses in the surface of the spring wire, as illustrated in FIGS. 4B, 4C and 5A, all three options permit a reliable and non-contacting recognition of defective spring wire regions provided with laser markings. In the event that the laser markings are formed as regions of the surface of the spring wire that are changed in color, as illustrated in FIGS. 4D and 5B, only a recognition unit in the form of an optical recognition unit is capable of reliably detecting the defective spring wire regions provided with laser markings.

The discharge unit 32 comprises a switch illustrated schematically in FIG. 7, which can be moved such that springs moving in particular by force of gravity through the discharge duct selectively reach the container for defective springs 34 or the container for intact springs 36.

When the recognition unit 24 recognizes a laser marking on the spring wire 10, it issues a corresponding signal to the control unit 26 which in turn sets the switch of the discharge unit 32 such that springs produced from the spring wire 10 with laser marking enter the container for defective springs 34. When the recognition unit 24 recognizes no laser marking on the spring wire 10, the switch of the discharge unit 32 remains in the position in which the springs produced automatically reach the container for intact springs 36, or is moved into this position in case the recognition unit 24 had recognized a laser marking before.

The spring production device 60 according to the invention permits a continuous and uninterrupted production of springs from a spring wire 10. Defective regions of the spring wire are recognized automatically, the spring production device 60 however need not be stopped, which would lead to machine downtimes, reduced efficiency as well as higher costs. Rather, the springs produced from such defective regions of the spring wire 10 are fed automatically to a different container, namely the container for defective springs 34.

While the invention has been described with reference to exemplary embodiments and applications scenarios, it will be understood by those skilled in the art that various changes may be made and equivalents may be substituted for elements thereof without departing from the scope of the claims Therefore, it is intended that the invention not be limited to the particular embodiments disclosed, but that the invention will include all embodiments falling within the scope of the appended claims and can be applied to various application in the industrial as well as commercial field.

What is claimed is:

1. A device for producing a spring wire (2), comprising:
a wire production apparatus (8) which is designed such that a spring wire (10) can be produced from a raw material, in particular by drawing;
a checking unit (14) which is designed such that the spring wire (10) can be checked for flaws, in particular material flaws and surface flaws; and
a laser marking unit (18) which is designed such that defective regions of the spring wire (10), in particular regions of the spring wire (10) having material and surface flaws, can be marked with a laser marking (44) such that part of the surface of the spring wire (10) can be removed or part of the surface of the spring wire (10) can be tempered in such a manner that the color of the surface of the spring wire (10) is changed in this part;
with the wire production apparatus (8) being designed such that the spring wire (10) can be guided past the checking unit (14) and past the laser marking unit (18).

2. A device for marking a spring wire (21), comprising:
a supply unit, in particular a supply roller (22) for supplying a spring wire (10);
a checking unit (14) which is designed such that the spring wire (10) can be checked for flaws, in particular for material and surface flaws; and
a laser marking unit (18) which is designed such that defective regions of the spring wire (10), in particular regions of the spring wire (10) having material and surface flaws, can be marked with a laser marking (44) such that a part of the surface of the spring wire (10) can be removed or that a part of the surface of the spring wire (10) can be tempered in such a way that the color of the spring wire (10) is changed in this part;
with the supply unit (22) being designed such that the spring wire (10) can be guided past the checking unit (14) and past the laser marking unit (18).

3. The device (2) according to claim 1 or 2,
wherein the laser marking unit (18) is designed such that, for removing part of the surface of the spring wire (10) in the defective regions of the spring wire (10), it directs a laser beam with a temperature above the melting temperature of the basic material of the spring wire (10) onto the spring wire (10).

4. The device (2) according to claim 1 or 2,
wherein the laser marking unit (18) is designed such that, for tempering a part of the surface of the spring wire (10) in the defective regions of the spring wire (10) such that the color of the surface of the spring wire (10) is changed in this part, it directs a laser beam with a temperature of approx. 200° C. to 600° C. onto the spring wire (10).

5. The device (2) according to any of the preceding claims,
further comprising a control unit (16) connected to the checking unit (14) and the laser marking unit (18) and designed such that, during operation of the device (2), it receives signals on defective regions of the spring wire (10) from the checking unit (14) and controls the laser marking unit (18) such that the latter introduces at least one laser marking (44) into these defective regions of the spring wire (10).

6. The device (2) according to any of the preceding claims,
wherein the laser marking unit (18) comprises a radiation source (38) and/or a scanner optical system (40) or a projection mask and/or a focusing means (42) which is/are arranged such that they are directed towards the moving spring wire (10).

7. The device (2) according to any of the preceding claims,
wherein the laser marking unit (18) is designed such that the defective regions of the spring wire (10) are marked such that the laser marking (44) forms a machine-readable code, in particular a line code (54), a barcode (56) or a data matrix code (58), or a machine-readable text, and/or wherein the laser marking unit (18) is designed such that each defective region is respectively provided with the same laser marking (44), or that each defective region is respectively provided with an unambiguously distinguishable laser marking (44), and/or wherein the laser marking (44) contains additional information on the respectively marked defective region.

8. The device (2) according to any of the preceding claims,
wherein the laser marking unit (18) is arranged or designed such that the laser marking (44) is applied to the defective region or regions of the spring wire (10) such that it extends at least across large part of the circumference of the spring wire (10), in particular across the entire circumference of the same, or wherein the laser marking (44) is applied to the defective region or regions of the spring wire (10) such that it extends only across a partial region of the circumference of the spring wire (10).

9. The device (2) according to any of the preceding claims,
wherein the checking unit (14) for checking the spring wire (10) for flaws is designed as optical checking unit, as eddy current checking unit or as flux leakage measuring unit.

10. The device (2) according to any of the preceding claims,
wherein the checking unit (14) and the laser marking unit (18) are arranged beside each other, and wherein in particular the checking unit (14), as seen in the direction of movement of the spring wire (10), is arranged in front of or subsequent to the laser marking unit (18).

11. The device (2) according to any of the preceding claims,
further comprising a winding unit (20), in particular a roller, onto which the spring wire (10) including the defective region/regions provided with one or more laser markings (44) can be wound.

12. The device (2) according to any of the preceding claims,
further comprising at least one wire guide (12), in particular a first wire guide (12) arranged upstream of the checking unit (14) and the laser marking unit (18), and a second wire guide (12) arranged downstream of the checking unit (14) and the laser marking unit (18) and upstream of the winding roller (20).

13. A method for producing a spring wire (10), comprising the following steps:
producing, in particular drawing, a spring wire (10) from a raw material;
checking the spring wire (10) for flaws, in particular for material and surface flaws; and
marking the defective regions of the spring wire by means of a laser marking unit (18), with the laser marking unit (18) removing part of the surface of the spring wire (10) or with the laser marking unit (18) tempering part of the surface of the spring wire (10) such that the color of said part is changed.

14. A method for marking a spring wire (10), comprising the following steps:
supplying a spring wire (10) by means of a supply unit, in particular a supply roller (22);
checking the spring wire (10) for flaws, in particular for material and surface flaws; and
marking the defective regions of the spring wire by means of a laser marking unit (18), with the laser marking unit (18) removing part of the surface of the spring wire (10) or with the laser marking unit (18) tempering part of the surface of the spring wire (10) such that the color of said part is changed.

15. The method according to claim 13 or 14,
wherein the laser marking unit (18) directs a laser beam with a temperature above the melting temperature of the basic material of the spring wire (10) onto the spring wire (10) in order to remove part of the surface of the spring wire (10) in the defective regions of the spring wire (10).

16. The method according to claim 13 or 14,
wherein the laser marking unit (18) directs a laser beam with a temperature of approx. 200° C. to 660° C. onto the spring wire (10) in order to temper part of the surface of the spring wire (10) in the defective regions of the spring wire (10) such that the color of the surface of the spring wire (10) is changed in this part.

17. The method according to any of claims 13 to 16,
therein the defective regions of the spring wire (10) are marked by means of a laser marking unit (18) such that the laser marking (44) forms a machine-readable code, in particular a line code, a barcode (56) or a data matrix code (58), or a machine-readable text.

18. The method according to any of claims 13 to 17,
wherein the defective regions of the spring wire (10) are marked by means of a laser marking unit (18) such that each defective region is respectively provided with the same laser marking (44).

19. The method according to any of claims 13 to 18,
wherein the defective regions of the spring wire (10) are marked by means of a laser marking unit (18) such that each defective region is respectively provided with an unambiguously distinguishable laser marking (44), and/or wherein the laser marking (44) contains additional information on the respectively marked defective region.

20. The method according to any of the claims 13 to 19,
wherein the laser marking (44) is applied to the defective region or regions of the spring wire (10) such that it extends at least across large part of the circumference of the spring wire (10), in particular across the entire circumference of the same, or wherein the laser marking (44) is applied to the defective region or regions of the spring wire (10) such that it extends only across a partial region of the circumference of the spring wire (10).

21. The method according to any of claims 13 to 20,
wherein the method steps of checking the spring wire (10) for flaws and of marking the defective regions of the spring wire (10) are carried out during continuous movement of the drawn wire.

22. The method according to any of claims 13 to 21,
wherein the laser marking unit (18) comprises a radiation source (38) and/or a scanner optical system (40) or a projection mask and/or a focusing means (42) which is/are designed such that they are directed towards the moving spring wire (10).

23. The method according to any of claims 13 to 22,
wherein checking of the spring wire (10) for flaws is effected by means of an optical checking method or by means of an eddy current checking method.

24. A device for producing springs from a spring wire (60), comprising:
a spring wire supply unit (28), in particular a supply roller (22), for supplying spring wire (10) in which defective regions, in particular regions having material and surface flaws, are marked with a laser marking (44);
a recognition unit (24) which is designed such that it recognizes laser markings (44) on the spring wire (10);
a spring production unit (30), in particular a coiling machine, which is designed such that springs can be produced from the spring wire (10) continuously and without interruption, and in particular can be coiled and cut to length;
a discharge unit (32), in particular a discharge duct having a switch, which is designed such that springs produced from spring wire (10) without laser marking are discharged into a first area, in particular a container with non-defective springs (36), and springs produced from spring wire (10) with laser marking (44) are discharged into a second area, in particular a container with defective springs (34).

25. The device (60) according to claim 24,
further comprising a control unit (26) connected to the recognition unit (24) and the discharge unit (32) and designed such that, during operation of the device (60), it receives signals on defective regions of the spring wire (10) from the recognition unit (24) and controls the discharge unit (32) such that springs produced from the defective region of the spring wire (10) are passed to the second area, in particular the container with defective springs (34).

26. The device according to claim 24 or 25,
wherein the recognition unit (24) is designed as optical recognition unit, as eddy current recognition unit or as a flux leakage recognition unit.

27. A method for producing springs from a spring wire, comprising the following steps:
supplying spring wire (10), in which defective regions, in particular regions having material and surface flaws, are marked with a laser marking (44), by means of a spring wire supply unit (28);
recognizing laser markings (44) on the spring wire (10) by means of a recognition unit (24);
continuous and uninterrupted production, in particular coiling and cutting to length of springs from the spring wire (10) by means of a spring production unit (30);
discharging those springs that were produced from spring wire (10) without laser marking into a first area, in particular a container with non-defective springs (36) and discharging those springs that were produced from spring wire (10) with laser marking (44) into a second area, in particular a container with defective springs (34), by means of a discharge unit (32), in particular a discharge duct having a switch.

28. A spring wire (10), comprising:
a raw material, in particular of spring steel, having a substantially constant elongated outline;
wherein defective regions of the spring wire (10), in particular regions of the spring wire (10) having material and surface flaws, are marked with a laser marking (44) in which the surface of the spring wire (10) is recessed in relation to the surface of adjacent regions and with respect to the longitudinal central axis, or in which the surface of the spring wire (10) is changed in color with respect to the surface of adjacent regions.

29. The spring wire (10) according to claim 28,
wherein in case the laser marking (44) is provided in the form of a recessed surface region of the spring wire (10), the recess has a depth from 10 μm to 1 mm as measured from the non-recessed surface to the longitudinal central axis.

30. The spring wire (10) according to claim 28,
wherein in case the laser marking (44) is provided in the form of a surface region of the spring wire (10) that is changed in color, the color of the surface region of the spring wire (10) that is changed in color comprises white-yellow, straw-yellow, golden yellow, yellow-brown, brown-red, red, purple, violet, dark blue, cornflower blue, light blue, blue-gray or gray, with the color of the remaining surface regions of the spring wire (10) that are not changed in color being silvery-gray.

31. The spring wire (10) according to any of claims 28 to 30,
therein the laser marking (44) forms a machine-readable code, in particular a line code, a barcode (56) or a data matrix code (58), or a machine-readable text, and/or wherein each defective region is respectively provided with the same laser marking (44), or wherein each defective region is respectively provided with an unambiguously distinguishable laser marking (44) and/or wherein the laser marking (44) contains additional information on the respectively marked defective region.

32. The spring wire (10) according to any of claims 28 to 31,
wherein the laser marking (44) extends at least across large part of the circumference of the spring wire (44), in particular across the entire circumference of the same, or wherein the laser marking (44) extends only across a partial region of the circumference of the spring wire (10).

33. A device according to any of claims 1 to 12 or 24 to 26, a method according to any of claim 13 to 23 or 27 or a spring wire according to any of claims 28 to 33, wherein the inventive spring wire comprises as material spring steel, in particular SiCr-alloyed spring steel, SiCrV-alloyed spring steel or SiCrNiV-alloyed spring steel.
